(19) United States
(12) Patent Application Publication
(10) Pub. No.: US 2013/0061704 A1
(43) Pub. Date: Mar. 14, 2013

(54) ENVELOPING SPIROID GEAR ASSEMBLIES AND METHOD OF MANUFACTURING THE SAME

(71) Applicants: Shawn M. Green, Alexandria, MN (US); DuWayne R. Cookman, Fergus Falls, MN (US); James H. Pospisil, Alexandria, MN (US)

(72) Inventors: Shawn M. Green, Alexandria, MN (US); DuWayne R. Cookman, Fergus Falls, MN (US); James H. Pospisil, Alexandria, MN (US)

(73) Assignee: ILLINOIS TOOL WORKS INC., Glenview, IL (US)

(21) Appl. No.: 13/467,445

(22) Filed: May 9, 2012

Related U.S. Application Data
(63) Continuation-in-part of application No. 13/255,655, filed on Sep. 9, 2011.

(51) Int. Cl. F16H 55/17; B23F 9/08; F16H 55/06

(52) U.S. Cl. 74/458; 409/12; 409/11

(57) ABSTRACT

A gear assembly includes a single piece gear body having a first axis of rotation and including opposing first and second surfaces each having spiroid gear teeth formed therein. The gear teeth radially extend outward from the first axis of rotation. The gear teeth on the first surface also extend from the first surface toward the second surface and the gear teeth on the second surface also extend from the second surface toward the first surface. The gear teeth on the first surface and the gear teeth on the second surface are configured to concurrently engage teeth of a pinion such that rotation of the pinion is translated to rotation of the gear body around the first axis of rotation.

### CROSS-REFERENCE TO RELATED APPLICATIONS

This application is a continuation-in-part of U.S. patent application Ser. No. 13/255,655, filed 5 Jan. 2012 (the “'655 application”), which claims priority to U.S. Patent Application Ser. No. 61/158,801, filed 10 Mar. 2009 (the “'801 application”). The entire disclosures of the '655 application and the '801 application are incorporated by reference.

### BACKGROUND

The presently described subject matter generally relates to an enveloping gear arrangement and, more particularly, to an enveloping gear arrangement that uses a spiroid gear arrangement.

Gears are one of the fundamental mechanical machines and have been in use for centuries. Gears are used to, among other things, transmit power from one device to another and change the direction of force. Many types of gears are known, such as straight gears, angle gears, bevel gears, worm gears, combinations of these gears, and others. Also known are SPIROID® brand gears that use a curved gear tooth. Such a configuration of gears permits larger loads to be transferred due to the increased surface area of gear tooth relative to a straight gear formed on a similar blank.

Certain applications require gears that withstand high loads (e.g., forces). Generally, the ability to withstand such forces is accomplished by using larger gears to increase the area on the gear teeth over which the forces are exerted. The ability to withstand forces is balanced against size requirements, or conversely size limitations, of the gear assembly. While the spiroid gear accomplishes this, at times, even smaller size limitations may apply. One such gear tooth form is disclosed in Saari, U.S. Pat. No. 3,631,736 (the “'736 application”), commonly assigned with the present application and incorporated herein by reference.

Additionally, some gear assemblies are formed from multiple parts or sections. For example, a first part or section having a first set of gear teeth may be formed and a second part or section having a second set of gear teeth may be separately formed. The two parts or sections may then be coupled together using welding, adhesives, fasteners, and the like. The combined parts or sections may then mate with another geared body, such as a pinion, to translate rotation of the other geared body (e.g., the pinion) into rotation of the combined parts or sections. Due to the coupling of the separately formed parts or sections, however, the torques that may be transferred from the other geared body and the combined parts or sections may be limited.

Accordingly, there is a need for a gear system that can withstand high loads/forces in a limited or small size application.

### BRIEF SUMMARY

In one embodiment, a hybrid spiroid and worm gear is formed as a gear body having an axis of rotation. The gear body has a plurality of spiroid gear teeth formed in a surface of the body, formed generally radially relative to the axis of rotation and a plurality of worm gear teeth formed in the body separate and apart from the spiroid teeth. The worm gear teeth are formed generally longitudinally relative to the axis of rotation of the gear. Alternatively, the gear body may not include the worm gear teeth.

It has been found that at least one embodiment of the hybrid spiroid gear disclosed herein provides a significant increase in torque capability for gearing without increasing the size of the gears.

In one embodiment that includes the worm gear, the gear body is formed having a pair of substantially opposing surfaces in which the spiroid gear teeth are formed a central hub, with the worm gear teeth formed between the opposing surfaces in the hub. The gear can be formed with a gap between the spiroid gear teeth and the worm gear teeth.

The gear body can be formed as two parts joined to one another at the hub in one aspect of the inventive subject matter disclosed herein. The two parts can be substantially identical to one another. The parts can be joined by press-fitting, welding, adhesive, fasteners or the like. Alternatively, the gear body may be formed as a single piece body. Such a gear body may not include separately formed parts that are joined together, such as by press-fitting the two parts together, welding the two parts together, adhering the two parts together using adhesives, fastening the two parts together using fasteners, or the like.

In an embodiment that includes the worm gear teeth, the teeth can be formed having a profile that is different from or the same as the profile of the spiroid gear teeth, where the profile is defined by a height and/or a pitch of the gear teeth.

In one embodiment, the gear is formed from a polymeric material, such as acetal material or the like. Alternatively, the gear may be formed from another material, such as aluminum, ductile iron, aluminum bronze, steel, high strength heat treated alloy steels, and the like. For example, the ability to form the gear as a single piece body in one embodiment (as opposed to forming the gear from multiple pieces that are joined together) can allow for the gear to be formed from materials that typically are not able to be welded together or otherwise connected and able to support relatively large forces or loads.

The hybrid spiroid gear assemblies disclosed herein (e.g., the hybrid spiroid and worm gear assembly and/or the spiroid gear assembly) can be configured to mesh with a pinion disposed at an angle that is other than normal to an axis of the gear body. The pinion can be formed with first and third spaced apart thread forms configured to mesh with the opposing surface spiroid gear teeth. In one embodiment, the pinion can include an intermediately disposed, second thread form configured to mesh with the gear worm teeth. Alternatively, the gear may not include the worm teeth and/or the pinion may not include the second thread form for meshing with gear worm teeth. The pinion first and third thread forms may be identical. The second thread form can be different from or identical to the first and third thread forms. Alternatively, the second thread form may not be included or provided in the gear body. The first, second and third thread forms can also be formed as a continuous thread form in the pinion.

One embodiment of method for making the hybrid spiroid and worm gear includes forming the first gear body part, forming the second gear body part, and joining the first and second gear body parts to form the hybrid spiroid and worm gear. The first and second body parts can be formed identical to one another.

In another embodiment, a spiroid gear assembly includes a single piece gear body having a first axis of rotation and including opposing first and second surfaces each having spiroid gear teeth formed therein. The gear teeth radially extend outward from the first axis of rotation. The gear teeth on the first surface also extend from the first surface toward the second surface and the gear teeth on the second surface also extend from the second surface toward the first surface. The gear teeth on the first surface and the gear teeth on the second surface are configured to concurrently engage teeth of a pinion such that rotation of the pinion is translated to rotation of the gear body around the first axis of rotation.

In another embodiment, a method (e.g., for forming a gear assembly) includes providing a single piece blank having a first axis of rotation. The blank includes opposing first and second surfaces. The method also includes positioning a hob between the first and second surfaces of the blank. The hob includes a second axis of rotation and cutting teeth positioned along a length of the hob. The hob is positioned such that the cutting teeth concurrently engage both of the first and second surfaces of the blank. The method further includes rotating the blank around the first axis of rotation and the hob around the second axis of rotation such that the cutting teeth of the hob concurrently cut gear teeth in each of the first and second surfaces of the blank to form a gear body of a spiroid gear assembly.

In another embodiment, a hobbing tool includes a body and one or more cutting teeth. The body is elongated along a first axis of rotation. The one or more cutting teeth encircle the body along at least a portion of a length of the body. The one or more cutting teeth also are spaced along the length of the body such that cutting teeth concurrently engage opposing first and second surfaces of a gear body blank. The body is configured to be rotated about the first axis of rotation while the gear body blank is rotated about a second axis of rotation such that the one or more cutting teeth concurrently cut gear teeth in both of the first and second surfaces of the gear body blank.

These and other features and advantages of the presently described inventive subject matter will be apparent from the following detailed description, in conjunction with the appended claims.

### BRIEF DESCRIPTION OF THE DRAWINGS

The benefits and advantages of the presently described inventive subject matter will become more readily apparent to those of ordinary skill in the relevant art after reviewing the following detailed description and accompanying drawings, wherein:

FIG. 1 is a top perspective view of one embodiment of a hybrid enveloping spiroid and worm gear (shown without the complementary pinion);

FIG. 2 is an enlarged view similar to the embodiment shown in FIG. 1;

FIG. 3 is a top view into a center of one embodiment of the gear assembly, looking at the central worm gear;

FIG. 3A is an enlarged view of one embodiment of a tooth on the worm gear;

FIG. 4 is a view similar to FIG. 3 and also illustrating one example of a pinion that can be used with one embodiment of the hybrid spiroid and worm gear;

FIG. 5 is a view of the pinion in place in the hybrid spiroid and worm gear, the pinion being skewed relative to the hybrid spiroid and worm gear axis in accordance with one embodiment;

FIG. 6 is an enlarged view of the pinion and hybrid spiroid and worm gear of (and as seen from an angle rotated about 90 degrees relative to) FIG. 5;

FIGS. 7A, 7B, and 7C are sectional views taken along lines 7A-7A, 7B-7B, and 7C-7C, respectively, in FIG. 6;

FIG. 8 is a view looking substantially along the pinion as the pinion resides in one embodiment of the hybrid spiroid and worm gear;

FIG. 9 is an illustration of a testing apparatus used to obtain torque data for the hybrid spiroid and worm gear and pinion assembly;

FIG. 10 illustrates a first perspective view of one embodiment of a single-piece enveloping spiroid gear assembly;

FIG. 11 illustrates a second perspective view of the single-piece hybrid enveloping spiroid gear assembly shown in FIG. 10;

FIG. 12 is a side view of the gear assembly shown in FIGS. 10 and 11;

FIG. 13 illustrates a perspective view of one embodiment of a gear system that includes the gear assembly shown in FIG. 10 and a pinion;

FIG. 14 is a side view of one embodiment of a single piece blank from which the gear assembly shown in FIG. 10 can be cut;

FIG. 15 is a side view of one embodiment of a dual thread cutting hob that may be used to cut the gear assembly shown in FIG. 10 from the single piece blank shown in FIG. 14;

FIG. 16 is a first perspective views of one embodiment of the hob shown in FIG. 15 cutting the teeth in opposing surfaces of the single piece blank shown in FIG. 14 to form the gear assembly shown in FIG. 10;

FIG. 18 illustrates one embodiment of the pinion shown in FIG. 13 engaged with the gear assembly shown in FIG. 10; and

FIG. 19 is a flowchart of one embodiment of a method for forming a single-piece gear assembly.

### DETAILED DESCRIPTION

While the presently described inventive subject matter is susceptible of embodiment in various forms, there is shown in the drawings and will hereinafter be described example embodiments of the inventive subject matter with the understanding that the present disclosure is to be considered an exemplification of the inventive subject matter and is not intended to limit the scope of the inventive subject matter to the specific illustrated embodiments.

It should be understood that the title of this section of this specification, namely, “Detailed Description,” relates to a requirement of the United States Patent Office, and does not imply, nor should be inferred to limit the subject matter disclosed herein.

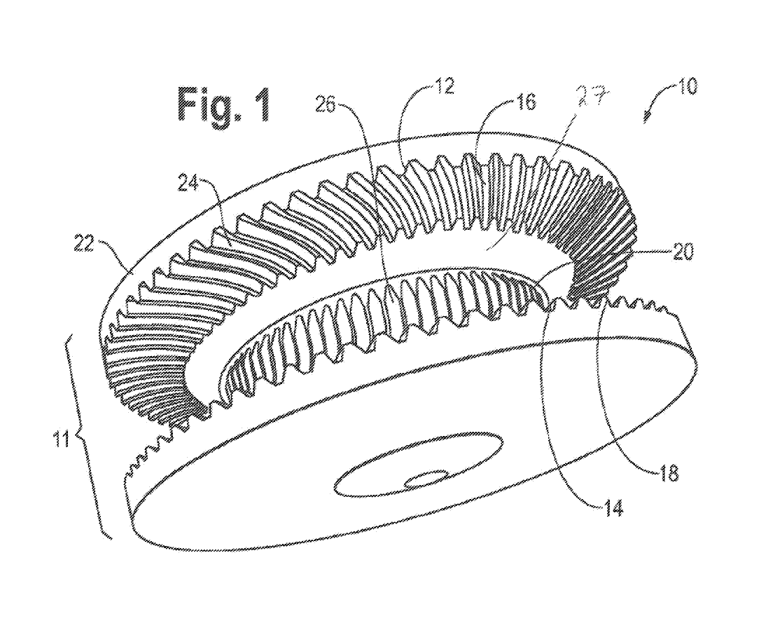

Referring now to the figures and in particular to FIG. 1, there is illustrated one embodiment of a hybrid enveloping spiroid and worm gear (also referred to as a gear assembly) 10. The gear assembly 10 is a double gear 11 in which two facing (e.g., opposing) surfaces 12, 14 have gear teeth 16, 18 formed therein. The assembly 10 includes a central hub region 20 that interconnects the opposing gears surfaces 12, 14.

The opposing gear surfaces 12, 14 have teeth 16, 18 that extend from the periphery 22, partially downward toward the central hub region 20. In the illustrated gear assembly 10, the opposing surfaces 12, 14 are formed with a spiroid gear form 24 and the central hub portion 20 is formed with a worm gear form 26. A gap 27 is defined between the spiroid gear form 24 and the worm gear form 26. The spiroid gear form 24 has a curved tooth profile 28. In the illustrated embodiment, the worm gear 26 has lower gear tooth profile. It will, however, be appreciated that the tooth profile of the worm gear form 26 can be the same as the tooth profile of the spiroid gear form 24 insofar as the pitch, tooth height, and/or like tooth characteristics.

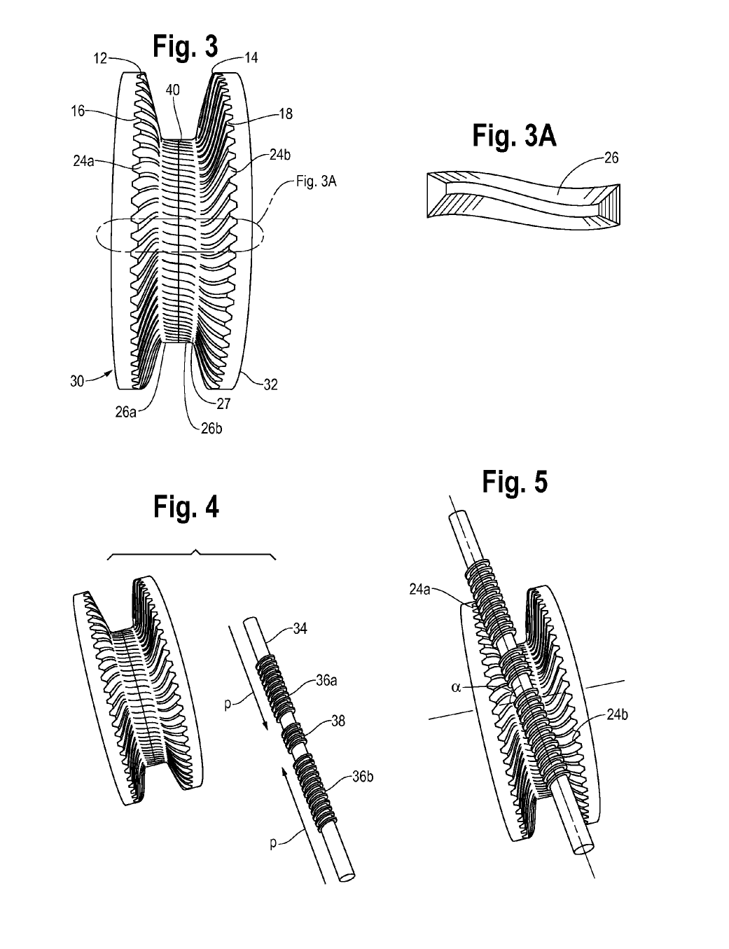

Referring to FIG. 3, the assembly 10 is formed as a pair of elements 30, 32, each element 30, 32 having the spiroid face gear face or profile 24 and one-half 26a, 26b of the worm gear 26 profile. The two elements 30, 32, which are defined by a parting line 40 in the gear assembly 10, are then joined to one another (e.g., by press-fitting, welding, adhesive, fasteners, or the like) to form the double gear element 11. In a present element 11, the two half-gear elements 30, 32 each include one-half of the worm gear 26 so that a single gear profile (and, for example, a single gear mold) can be used for each element or half 30, 32.

The illustrated gear system (the gear assembly 10 and a pinion 34) has a pinion 34 that has two different and separate tooth profiles 36, 38. Two outer pinion (worm) tooth profiles 36 (e.g., arrangements of one or more teeth of the pinion) are designed to engage the larger opposing spiroid gear profiles 24, while the inner pinion (worm) tooth profile 38 is designed to engage the central worm gear tooth profile 26. It will, however, be appreciated that the pinion 34 can be configured with a single tooth (worm pinion) profile and can also be formed having a continuous tooth profile along the length of the pinion 34. Alternately, the pinion 34 can be formed tapering (with a decreasing diameter) toward the center of the pinion 34 from the ends, as indicated at P in FIG. 4. The illustrated pinion is formed from metal, but, of course can be formed from other suitable materials.

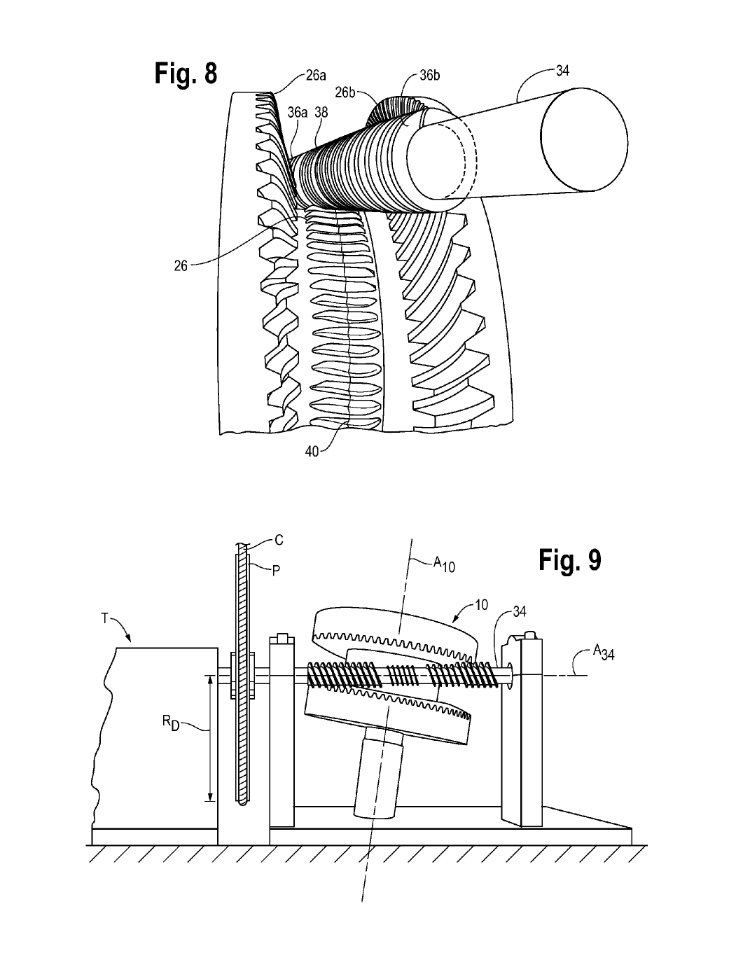

As shown in FIGS. 4 through 8, the illustrated spiroid and worm gear assembly 10 uses the pinion 34 that has an axis A₃₄ that is skewed (at skew angle α) relative to the axis A₁₀ of the gear assembly 10. In the illustrated embodiment, the axes A₃₄, A₁₀ are obliquely oriented with respect to each other. In this manner, a first portion 36a of the pinion 34 rests against one of the spiroid gear faces 24a while a second (or other) portion 36b of the pinion 34 rests against the other spiroid gear face 24b. And, the central portion 38 of the pinion 34 may engage the central worm gear formation 26.

Tests were conducted to compare the torque capability of the hybrid gear to that of a double spiroid gear (without the central worm gear) and a worm gear. This was conducted by measuring the torque at failure which was determined to be when the gear teeth fail under applied torque (referred to herein as the “maximum torque” or “maximum load”).

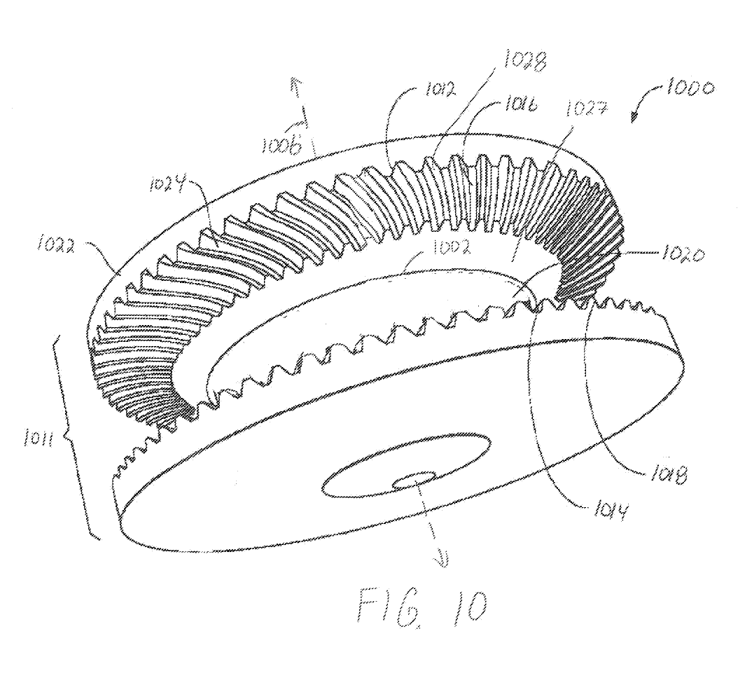

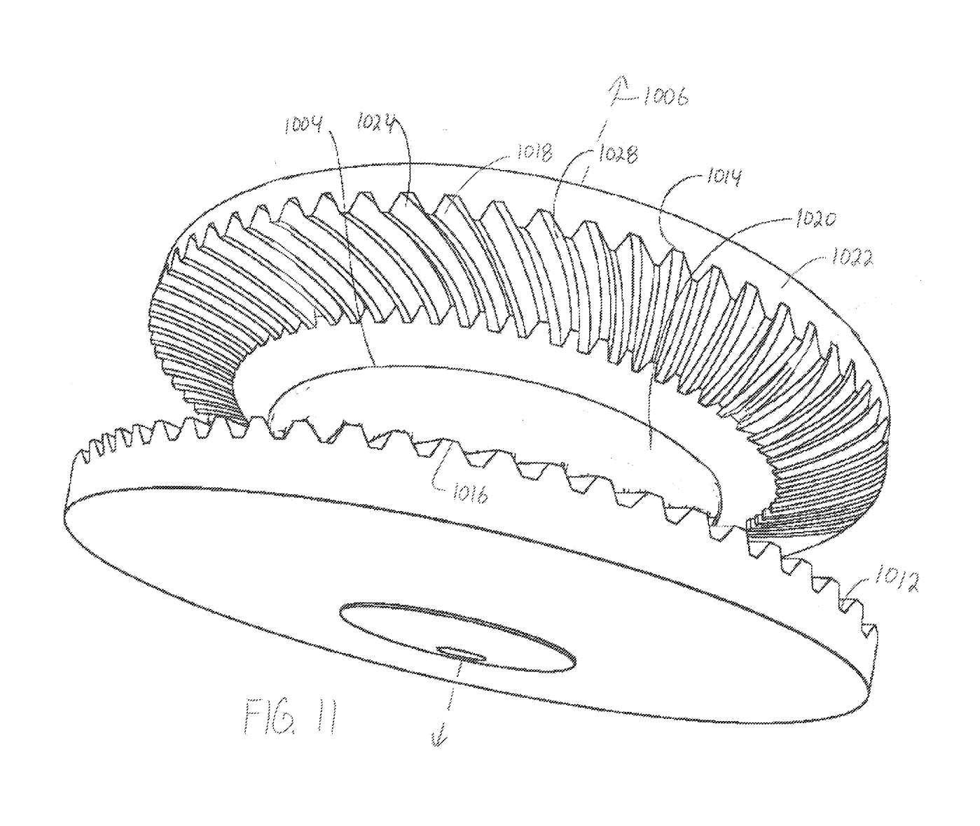

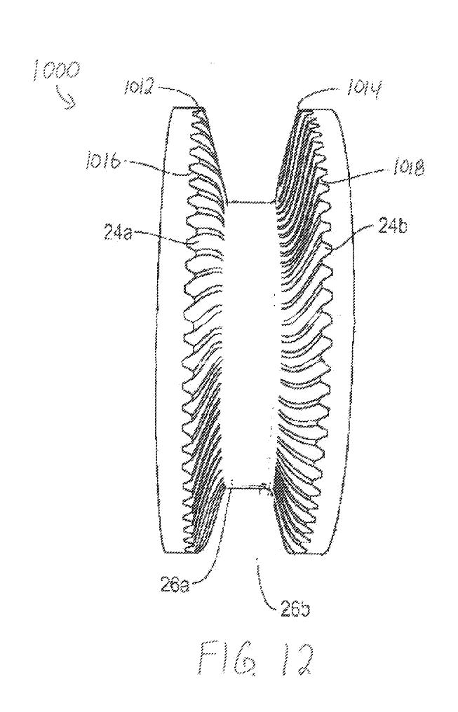

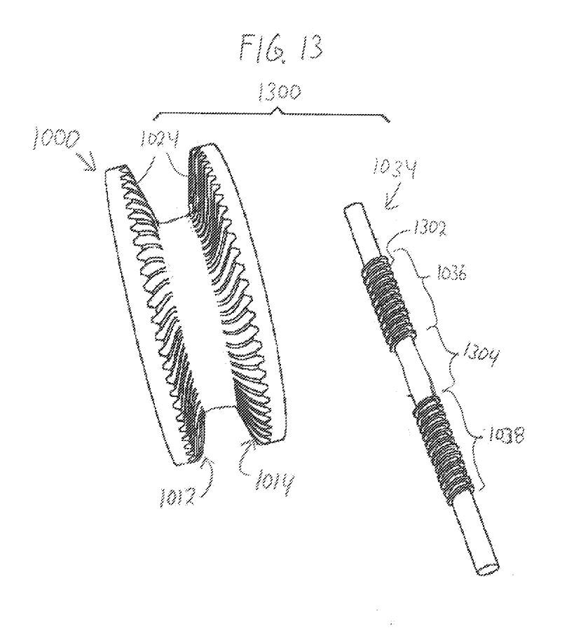

Testing was carried out using an ITW Intron device T as illustrated, in part, in FIG. 9. The test gear 10 was held in a fixed position and an input torque was applied to rotate the pinion 34. The pinion shaft was linked to the center of a 5 inch (e.g., 12.7 centimeters) diameter disk D. The input torque on the pinion was provided by a steel cord, and was determined to be equal to the force exerted on the disk by the cord C engaging the periphery P of the disk D and rotating the disk D, multiplied by the radius of disk r_{D}, which is 2.5 inches (e.g., 6.35 centimeters). The force was increased slowly until the gear teeth failed.

Three sets of test were conducted. The first set of tests was carried out on three worm gear samples. The calculated results of the test are shown in Table 1, below, which show the maximum load indicated for the worm gear.

The second set of tests was carried out on six double spiroid gear samples. The calculated results of the test are shown in Table 2, below, which show the maximum load indicated for the double spiroid gears.

The third set of tests was carried out on six hybrid enveloping spiroid and worm gear samples. The calculated results of the test are shown in Table 3, below, which show the maximum load indicated for the hybrid spiroid and worm gear.

TABLE 1
MAXIMUM TESTED LOAD FOR WORM GEAR

| | | Load at | Energy at | Load at |
|---|---|---|---|---|
| | Maximum | Break | Break | Preset Point |
| Sample | Load | (Standard) | (Standard) | (Tensile extension |
| No. | (lbf) | (lbf) | (ft-lbf) | 0.5 in) (lbf) |
| 1 | 15.31 | 9.13 | 4.57 | 3.84 |
| 2 | 14.15 | 9.21 | 3.29 | 4.11 |
| 3 | 14.45 | 9.54 | 3.46 | 3.61 |

TABLE 2
MAXIMUM TESTED LOAD FOR DOUBLE SPIROID GEAR

| | | Load at | Energy at | Load at |
|---|---|---|---|---|
| | Maximum | Break | Break | Preset Point |
| Sample | Load | (Standard) | (Standard) | (Tensile extension |
| No. | (lbf) | (lbf) | (ft-lbf) | 0.5 in) (lbf) |
| 1 | 70.06 | 62.25 | 22.75 | 5.82 |
| 2 | 76.09 | 65.24 | 24.11 | 3.88 |
| 3 | 75.21 | 66.20 | 24.14 | 4.44 |
| 4 | 76.14 | 66.75 | 24.01 | 7.27 |
| 5 | 72.66 | 60.23 | 22.90 | 6.26 |
| 6 | 72.06 | 62.10 | 22.62 | 9.36 |

TABLE 3
MAXIMUM TESTED LOAD FOR HYBRID
SPIROID AND WORM GEAR

| | | Load at | Energy at | Load at |
|---|---|---|---|---|
| | Maximum | Break | Break | Present Point |
| Sample | Load | (Standard) | (Standard) | (Tensile extension |
| No. | (lbf) | (lbf) | (ft-lbf) | 0.5 in) (lbf) |
| 1 | 81.46 | 68.35 | 30.16 | 5.72 |
| 2 | 79.91 | 63.70 | 28.13 | 6.56 |
| 3 | 84.21 | 68.96 | 30.86 | 5.16 |
| 4 | 84.82 | 70.35 | 30.41 | 5.35 |
| 5 | 81.68 | 61.66 | 27.94 | 2.14 |
| 6 | 88.80 | 74.40 | 33.03 | 4.04 |

In each case, the maximum load was calculated as the test device force multiplied by the disk radius (2.5 inches) and multiplied by the RPM ratio of 19. The RPM ratio is the ratio of rotational speed of the pinion to the tested gear. Thus, the maximum load is calculated as the test device force (in pounds) multiplied by 47.5 inches. All of the gears were made from the same material, Acetal 100.

With respect to the worm gear, the average (of three samples) maximum load at failure for the three tests was found to be 14.64 lbs, which corresponds to an average torque limit for the worm gear of 14.64×2.5×19=694.4 in-lbs.

With respect to the double spiroid gear samples, the average (of six samples) maximum load at failure was found to be 73.7 lbs. This corresponds to an average torque limit for the double spiroid gear of 73.7×2.5×19=3500.75 in-lbs.

And with respect to hybrid spiroid and worm gear samples, the average (of six samples) maximum load at failure was found to be 83.48 lbs. This corresponds to an average torque limit for the hybrid spiroid and worm gear of 83.48×2.5×19=3965.3 in-lbs.

As can be seen from the test results, the maximum load of at least one embodiment of the hybrid gear, compared to that of similar size and material gears, is considerably higher than the comparable worm gear (e.g., over 470 percent) and higher than the comparable double spiroid gear (e.g., 13.3 percent). Thus, the illustrated hybrid spiroid worm gear has been found to provide a significant increase in torque capability for gearing, without increasing the size of the gears.

It will be understood by those of ordinary skill in the art that the illustrated hybrid enveloping spiroid and worm gear assembly 10 permits a gear application in those instances where high torque handling is required and a physically small gear set is needed. The hybrid enveloping spiroid and worm gear assembly 10 can be formed from polymeric (e.g., plastic, resin) materials and still withstand high or out of the ordinary loads such as thrust loads (longitudinally along the pinion or normal to the gear assembly axis), without stripping the gear teeth 16, 18. It has also been found that higher torque loads can be accommodated since the load is distributed over both the spiroid gear surfaces 24, as well as the worm gear 26.

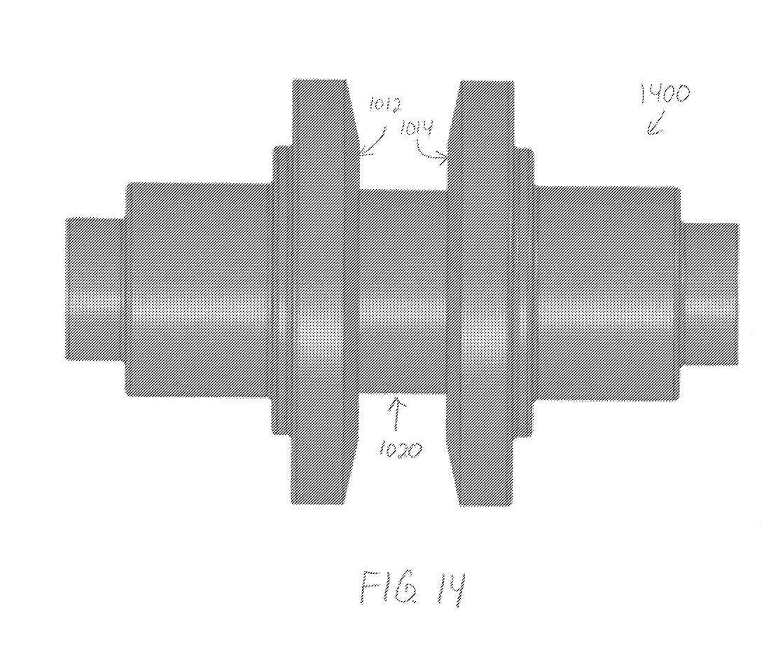

FIGS. 10 and 11 illustrate perspective views of one embodiment of a single-piece enveloping spiroid gear assembly 1000 from different perspectives. Similar to the gear assembly 10 shown in FIG. 1, the gear assembly 1000 is a double gear 1011 in which two facing (e.g., opposing) surfaces 1012, 1014 have gear teeth 1016, 1018 formed therein. The assembly 1000 includes a central hub region 1020 that interconnects the opposing gears surfaces 1012, 1014. The central hub region 1020 extends from a first interface 1002 (shown in FIG. 10) to a second interface 1004 (shown in FIG. 11) along an axis of rotation 1006 about which the gear assembly 1000 rotates (e.g., the gear assembly 1000 rotates around the axis of rotation 1006).

The opposing gear surfaces 1012, 1014 have the teeth 1016, 1018 that extend from an outer periphery 1022 of each gear surface 1012, 1014 and partially downward toward the central hub region 1020 and other gear surface 1012, 1014. In the illustrated embodiment, the opposing surfaces 1012, 1014 are formed with a spiroid gear form 1024, but the central hub region 1020 is not formed with any gear form. For example, the central hub region 1020 may not have any teeth to mesh with a worm gear, unlike the gear assembly 10 shown in FIG. 1. Alternatively, the central hub region 1020 may have a worm gear form that is similar to the worm gear form 26 (shown in FIG. 1). The spiroid gear form 1024 has a curved tooth profile 1028. Alternatively, the spiroid gear form 1024 may have another type of tooth profile 1028, such as a linear or non-curved tooth profile.

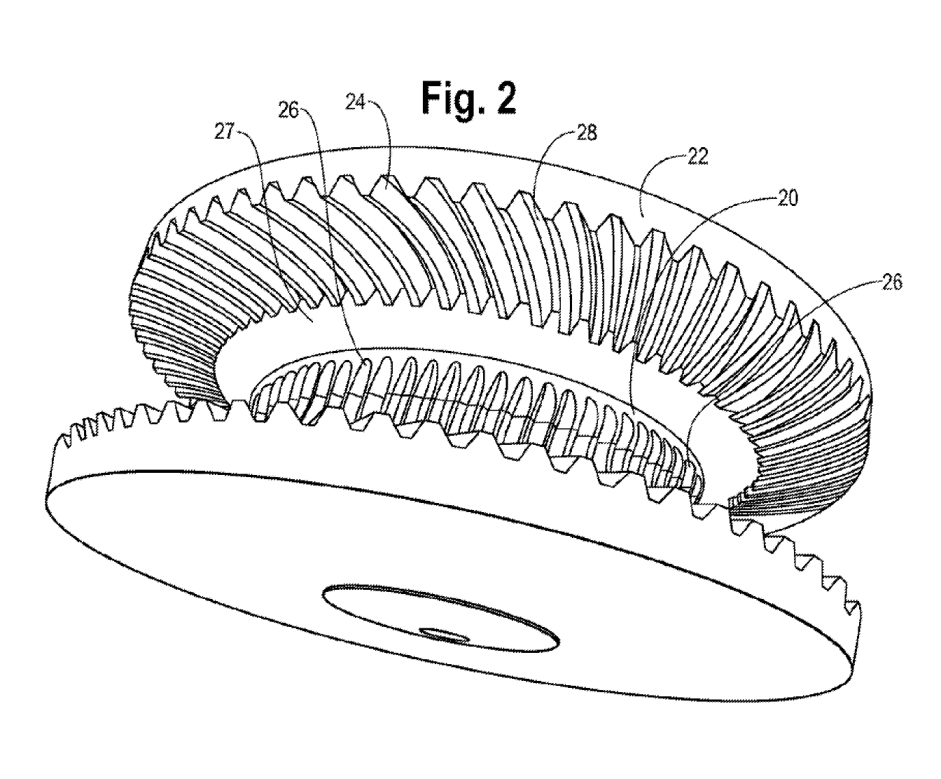

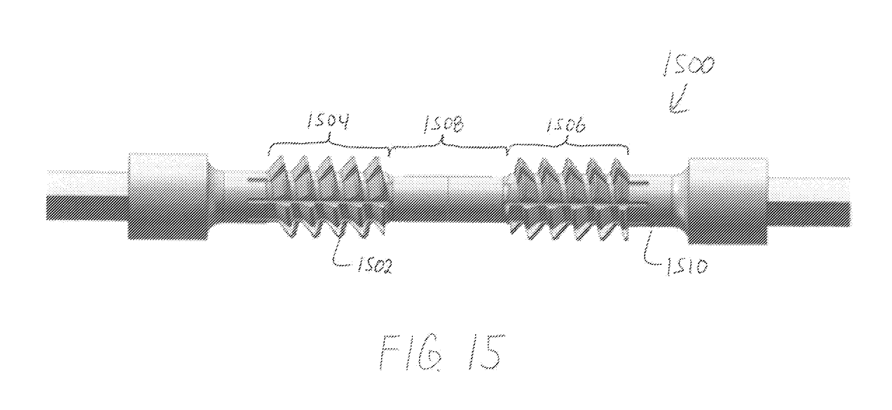

FIG. 12 is a side view of the gear assembly 1000 shown in FIGS. 10 and 11. In contrast to the gear assembly 10 shown in FIGS. 1 through 9, the gear assembly 1000 is formed as a single piece body. For example, instead of separately forming multiple pieces or elements (e.g., the pair of elements 30, 32 shown in FIG. 3) and then connecting the elements 30, 32 to form the gear assembly, the gear assembly 1000 is formed from a single piece, continuous body. As a result, there is no parting line or interface in the central hub region 1020 of the gear assembly 1000, unlike the parting line 40 (shown in FIG. 3) between the two elements 30, 32 of the gear assembly 10. The single piece gear assembly 1000 may be formed (e.g., the teeth 1016, 1018 can be cut into the opposing surfaces 1012, 1014) without press-fitting, welding, using adhesives, or using fasteners to couple multiple parts together.

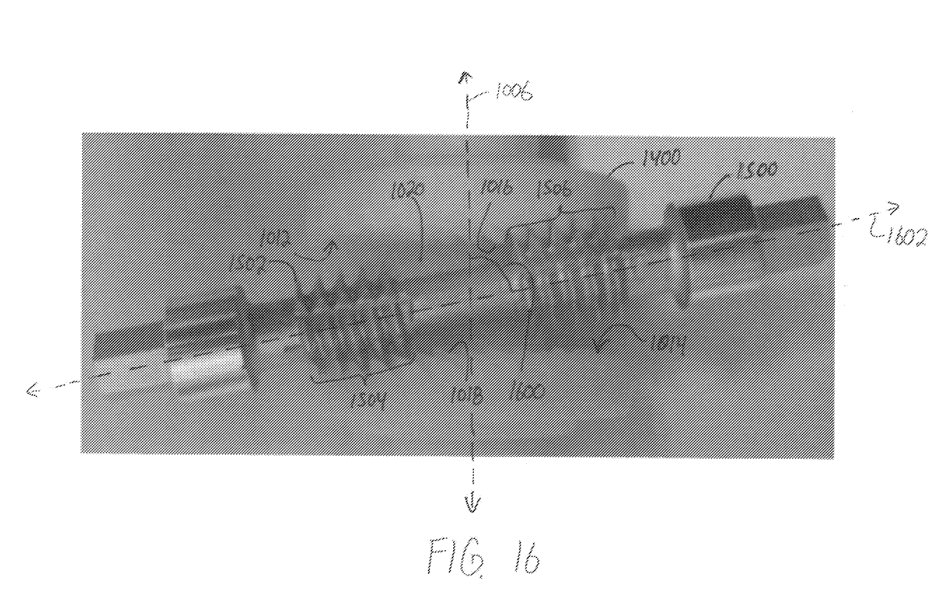

FIG. 13 illustrates a perspective view of one embodiment of a gear system 1300 that includes the gear assembly 1000 shown in FIG. 10 and a pinion 1034. The pinion 1034 has a tooth profile 1302 that is segmented into two spaced apart tooth profile segments 1036, 1038. The tooth profile 1302 is designed to engage the spiroid gear profiles 1024 of the gear assembly 1000. One tooth profile segment 1036 is positioned to engage the spiroid gear profile 1024 of one surface 1012 of the gear assembly 1000 while the other tooth profile segment 1038 is positioned to simultaneously or concurrently engage the spiroid gear profile 1024 of the opposing surface 1014 of the gear assembly 1000.

In the illustrated embodiment, in contrast to the pinion 34 (shown in FIG. 4), the pinion 1034 does not include a tooth profile over a middle or interconnecting segment 1304 that extends from one tooth profile segment 1036 to the other tooth profile segment 1038 along the length of the pinion 1034. Alternatively, the tooth profile 1302 may extend over the middle or interconnecting segment 1304 of the pinion 1034.

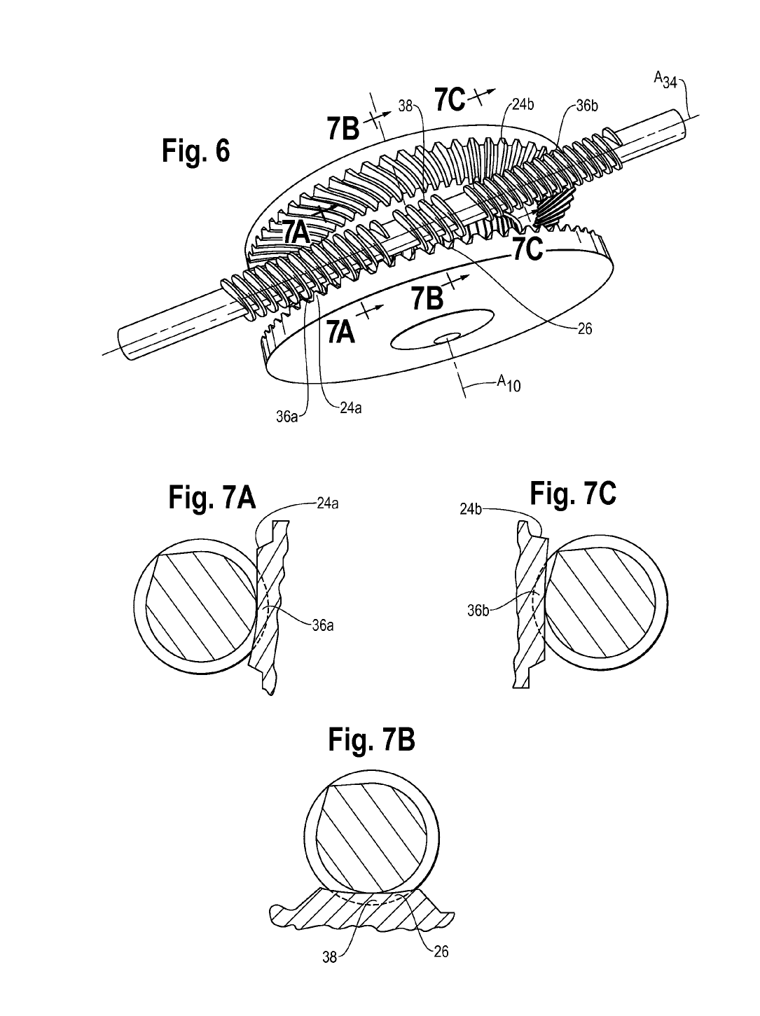

The gear assembly 1000 may operate in a manner similar to the gear assembly 10 shown in FIG. 1. For example, the pinion 1034 may have an axis similar to the axis A₃₄ (shown in FIG. 6) that is skewed (e.g., at the skew angle α shown in FIG. 5) relative to the axis 1006 (shown in FIG. 10) of the gear assembly 1000. The tooth profile segment 1036 of the pinion 1034 can rest against one of the spiroid gear faces 1012 while the tooth profile segment 1038 of the pinion 1034 rests against the other spiroid gear face 1014. The middle or interconnecting segment 1304 of the pinion 1034 may engage the central hub region 1020 of the gear assembly 1000. Alternatively, the middle or interconnecting segment 1304 may not engage the central hub region 1020 of the gear assembly 1000.

In order to create the gear assembly 1000, a single piece body or blank may be cut with a hob device, or hobbing tool. The hob device may concurrently or simultaneously cut the teeth 1016, 1018 of the gear assembly 1000 in the opposing surfaces 1012, 1014 of the single piece blank, as described below.

FIG. 14 is a side view of one embodiment of a single piece blank 1400 from which the gear assembly 1000 shown in FIG. 10 is cut. The single piece blank 1400 is a single, continuous body and is not formed from the joining of multiple separately formed or separate bodies. For example, no seams or interfaces between plural bodies or pieces may be present in the blank 1400.

The blank 1400 includes the opposing surfaces 1012, 1014 from which the teeth 1016, 1018 (shown in FIG. 10) are cut. The opposing surfaces 1012, 1014 are joined by the central hub region 1020 described above.

In one embodiment, because the gear assembly 1000 is cut from the single piece blank 1400 and is not formed from two or more separately formed pieces that later joined together, the gear assembly 1000 may be made from a wider range of materials than the gear assembly 10. For example, the gear assembly 1000 may be formed from stronger and/or lighter materials that typically are not joined together to form a larger body, such as aluminum, aluminum bronze, and the like. Other examples of materials include ductile iron, steel, high strength heat treated alloy steels, plastics, and the like.

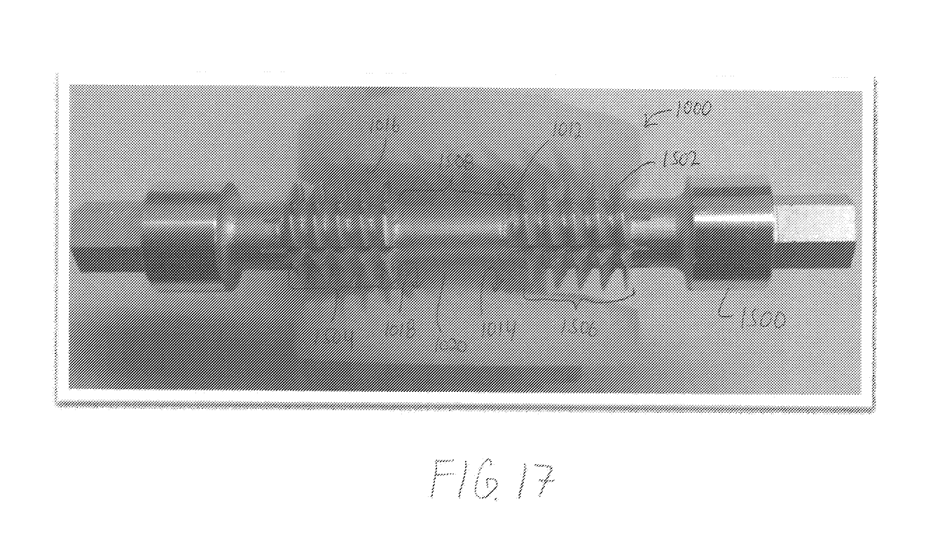

FIG. 15 is a side view of one embodiment of a dual thread cutting hob 1500 that may be used to cut the gear assembly 1000 (shown in FIG. 10) from the single piece blank 1400 (shown in FIG. 14). The hob 1500 is a hobbing tool having an elongated body 1510 having cutting teeth 1502 that encircle the body 1510. The cutting teeth 1502 may extend around the body 1510 along a helical or spiral path. The cutting teeth 1502 are arranged on the body 1510 to concurrently or simultaneously cut into the surfaces 1012, 1014 (shown in FIG. 14) of the single piece blank 1400. The cutting teeth 1502 are divided into cutting segments 1504, 1506 that are spaced apart along the length of the hob 1500 in the illustrated embodiment. The cutting teeth 1502 in the cutting segment 1506 may cut the teeth 1016 (shown in FIG. 10) into the surface 1012 of the single piece blank 1400 while the cutting teeth 1502 in the other cutting segment 1504 concurrently or simultaneously cut the teeth 1018 (shown in FIG. 10) into the surface 1014 of the single piece blank 1400. Alternatively, the cutting teeth 1502 in the cutting segment 1504 may cut the teeth 1016 into the surface 1012 of the single piece blank 1400 while the cutting teeth 1502 in the other cutting segment 1506 concurrently or simultaneously cut the teeth 1018 into the surface 1014 of the single piece blank 1400. A middle or interconnecting segment 1508 of the hob 1500 extends from the cutting segment 1504 to the cutting segment 1506 along the length of the hob 1500 may not include any cutting teeth. As a result, the middle or interconnecting segment 1508 may not cut any teeth into the single piece blank 1400. Alternatively, the middle or interconnecting segment 1508 may include cutting teeth that form teeth in the single piece blank 1400.

During cutting of the single piece blank 1400, the hob 1500 is placed between the surfaces 1012, 1014 of the single piece blank 1400. The hob 1500 may be oriented at a skew angle that is similar to the orientation of the pinion 34 with respect to the gear assembly 10 shown in FIG. 5. For example, the hob 1500 may be positioned such that the cutting teeth 1502 of the cutting segment 1506 engage the surface 1012 of the single piece blank 1400 and the cutting teeth 1502 of the cutting segment 1504 engage the opposing surface 1014 of the single piece blank 1400.

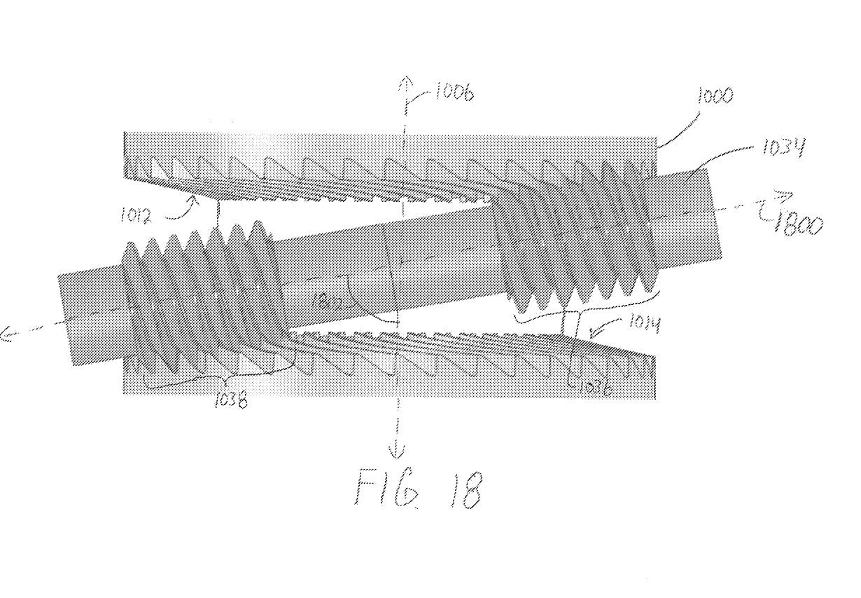

FIGS. 16 and 17 are perspective views of one embodiment of the hob 1500 cutting the teeth in the opposing surfaces 1012, 1014 of the single piece blank 1400 to form the gear assembly 1000. As shown in FIG. 16, the hob 1500 is oriented at a skew angle 1600 when cutting the teeth 1016, 1018 in the blank 1400. The skew angle 1600 may be measured between an axis of rotation 1602 of the hob 1500 (which also represents the direction of elongation of the hob 1500 in the illustrated embodiment) and the axis of rotation 1006 of the gear assembly 1000 that will be formed from the single piece blank 1400. In the illustrated embodiment, the skew angle 1600 is an oblique angle.

During the cutting of the teeth 1016, 1018 in the single piece blank 1400, the hob 1500 is positioned so that the cutting teeth 1502 in the cutting segment 1506 engage the surface 1012 of the blank 1400 while the cutting teeth 1504 in the cutting segment 1504 engage the opposing surface 1014 of the blank 1400. In one embodiment, the middle or interconnecting segment 1508 of the hob 1500 may engage the center hub region 1020 of the blank 1400. Alternatively, the middle or interconnecting segment 1508 of the hob 1500 may be spaced apart from the center hub region 1020 of the blank 1400. The hob 1500 may rotate about (e.g., around) the axis of rotation 1602 while the blank 1400 rotates about the axis of rotation 1006 to simultaneously or concurrently cut the teeth 1016, 1018 in the opposing surfaces 1012, 1014 of the blank 1400. Once the hob 1500 has cut the teeth 1016, 1018 into the blank 1400 around the axis of rotation 1006 of the blank 1400, the gear assembly 1000 is formed, as shown in FIG. 17. The hob 1500 may be moved away from the surfaces 1012, 1014 of the gear assembly 1000 and removed from between the surfaces 1012, 1014. In one embodiment, because the hob 1500 does not include cutting teeth 1502 in the middle or interconnecting segment 1508, the center hub region 1020 of the gear assembly 1000 does not include teeth, as described above.

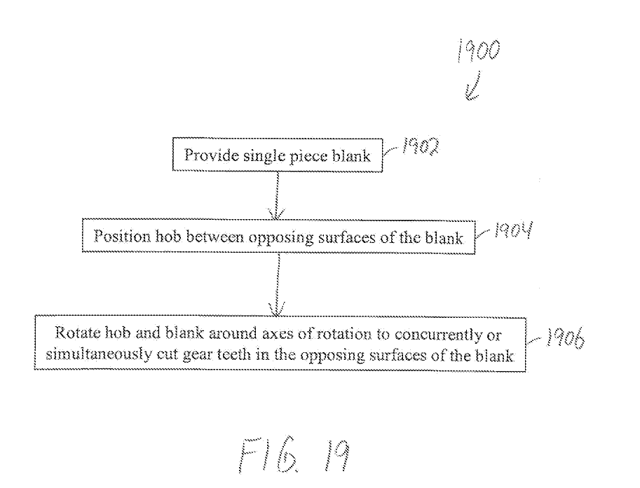

FIG. 18 illustrates one embodiment of the pinion 1034 engaged with the gear assembly 1000. The gear assembly 1000 is engaged with the pinion 1034 having an axis 1800 that is skewed (at a skew angle 1802) relative to the axis of rotation 1006 of the gear assembly 1000. The tooth profile segment 1036 of the pinion 1034 rests against the surface 1012 of the gear assembly 1000 while the tooth profile segment 1038 of the pinion 1034 rests against the opposing surface 1014 of the gear assembly 1000. The pinion 1034 is rotated about (e.g., around) the axis of rotation 1800 to drive the gear assembly 1000 to rotate about the axis of rotation 1006.

Forming the gearing assembly 1000 using the dual thread cutting hob 1500 can allow for a wider range of materials to be used in the gearing assembly 1000. As described above, materials that typically cannot be easily welded or securely fastened to each other can be used because the teeth 1016, 1018 of the gearing assembly 1000 are formed by cutting into a single piece body 1400.

Simultaneously or concurrently cutting the teeth 1016, 1018 into the opposing surfaces 1012, 1014 of the gear assembly 1000 can improve the timing (e.g., relative spacing) of the teeth 1016 and the teeth 1018 compared to separately cutting the teeth 1016 during one cutting procedure and cutting the teeth 1018 during a separate cutting procedure. The timing (e.g., spacing) of the cutting teeth 1502 of the hob 1500 can be the same as the timing of the teeth of the pinion 1034 such that the simultaneous or concurrent cutting of the teeth 1016 and the teeth 1018 on the opposing surfaces 1012, 1014 automatically aligns the teeth 1016 and the teeth 1018 with the teeth of the pinion 1034 during a single cutting operation. The improved timing of the gear assembly 1000 can reduce backlash relative to gear assemblies having the teeth 1016 and the teeth 1018 separately cut or formed. For example, the backlash can be reduced to 0.013 millimeters or less. Alternatively, the backlash can be reduced to a smaller distance.

FIG. 19 is a flowchart of one embodiment of a method 1900 for forming a single-piece gear assembly. The method 1900 may be used to form the gear assembly 1000 shown in FIG. 10. At 1902, a single piece blank is provided. For example, the blank 1400 (shown in FIG. 14) may be provided. The blank is formed from a single, continuous body of a material, as described above. The blank includes opposing surfaces that are separated from a center hub region. The outer periphery of the opposing surfaces may have a larger diameter than the outer periphery of the center hub region, as shown in FIG. 14.

At 1904, a hob is positioned between the opposing surfaces of the single piece blank. For example, the hob 1500 (shown in FIG. 15) may be positioned between the opposing surfaces 1012, 1014 (shown in FIG. 10) of the single piece blank 1400. The hob can include cutting teeth that are spaced similar to the teeth of a pinion that will mesh with the teeth that are to be cut into the opposing surfaces of the blank. The hob may be positioned at a skew angle that will be the same or substantially similar skew angle of the pinion that will mesh with the teeth that are to be cut into the opposing surfaces of the bank. In one embodiment, the cutting teeth of the hob are spaced such that the cutting teeth engage both opposing surfaces of the blank at the same time.

At 1906, the hob and blank are rotated about respective axes of rotation to cut the teeth into the opposing surfaces of the blank. For example, the hob 1500 can be rotated about the axis of rotation 1602 (shown in FIG. 16) and the blank 1400 can be rotated about the axis of rotation 1006 (shown in FIG. 10). The rotation of the hob and the blank causes the cutting teeth to concurrently or simultaneously cut the teeth that will mesh with the pinion in both opposing surfaces. Once the teeth are formed into the opposing surfaces, the gear assembly is formed such that a pinion (such as the pinion 1034 shown in FIG. 10) can mesh with the teeth on both opposing surfaces of the gear assembly to translate rotation of the pinion into rotation of the gear assembly.

It will be understood by those of ordinary skill in the art that the illustrated enveloping gear assemblies 10, 1000 permit a gear application in those instances where high torque handling is required and a physically small gear set is needed. The enveloping gear assemblies 10, 1000 can be formed from a variety of materials and still withstand high or out of the ordinary loads such as thrust loads (longitudinally along the pinion or normal to the gear assembly axis), without stripping the gear teeth 16, 18, 1016, 1018. It has also been found that higher torque loads can be accommodated since the load is distributed over both the spiroid gear surfaces 24, 1024.

Although not exhaustive nor limiting, it is anticipated that the illustrated gear systems can be used in a variety of applications, including (medical) pump and valve applications, aerospace systems and robotics applications, automobile and transportation systems, power systems, wind energy, mining systems, as well as general manufacturing uses.

All patents referred to herein, are hereby incorporated herein by reference, whether or not specifically done so within the text of this disclosure.

In the disclosures, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the presently described inventive subject matter. It is to be understood that no limitation with respect to the specific embodiments illustrated is intended or should be inferred. The disclosure is intended to cover by the appended claims all such modifications as fall within the scope of the claims.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

What is claimed is:

1. A gear assembly comprising:
a single piece gear body having a first axis of rotation, the gear body including opposing first and second surfaces each having spiroid gear teeth formed therein, the gear teeth radially extending outward from the first axis of rotation, the gear teeth on the first surface also extending from the first surface toward the second surface, the gear teeth on the second surface also extending from the second surface toward the first surface, wherein the gear teeth on the first surface and the gear teeth on the second surface are configured to concurrently engage teeth of a pinion such that rotation of the pinion is translated to rotation of the gear body around the first axis of rotation.

2. The gear assembly of claim 1, wherein the opposing first and second surfaces of the gear body are spaced apart by a center hub region.

3. The gear assembly of claim 2, wherein the center hub region of the gear body does not include worm gear teeth.

4. The gear assembly of claim 1, wherein the single piece gear body is a continuous body.

5. The gear assembly of claim 1, wherein the gear teeth formed in the first surface and the second surface are configured to engage with the pinion when the pinion is oriented along a second axis of rotation that is obliquely angled with respect to the first axis of rotation of the gear body.

6. The gear assembly of claim 1, wherein the gear body is formed from aluminum.

7. The gear assembly of claim 1, wherein the gear body is formed from ductile iron.

8. The gear assembly of claim 1, wherein the gear body is formed from aluminum bronze.

9. The gear assembly of claim 1, wherein the gear body is formed from steel.

10. A method comprising:
providing a single piece blank having a first axis of rotation, the blank including opposing first and second surfaces;
positioning a hob between the first and second surfaces of the blank, the hob including a second axis of rotation and cutting teeth positioned along a length of the hob, the hob positioned such that the cutting teeth concurrently engage both of the first and second surfaces of the blank; and
rotating the blank around the first axis of rotation and the hob around the second axis of rotation such that the cutting teeth of the hob concurrently cut gear teeth in each of the first and second surfaces of the blank to form a gear body of a spiroid gear assembly.

11. The method of claim 10, wherein rotating the blank and the hob cuts the gear teeth in the first and second surfaces of the blank such that the gear teeth radially extend outward from the first axis of rotation of the blank, the gear teeth on the first surface also extending from the first surface toward the second surface, and the gear teeth on the second surface also extending from the second surface toward the first surface.

12. The method of claim 10, wherein rotating the blank and the hob cuts the gear teeth in the first and second surfaces of the blank such that the gear teeth on the first surface and the gear teeth on the second surface are configured to concurrently engage teeth of a pinion such that rotation of the pinion is translated to rotation of the gear body around the first axis of rotation.

13. The method of claim 10, wherein rotating the blank and the hob cuts the gear teeth in the first and second surfaces of the blank with the first and second surfaces spaced apart by a center hub region of the blank.

14. The method of claim 13, wherein rotating the blank and the hob does not cut gear teeth in the center hub region of the gear body.

15. The method of claim 10, wherein providing the single piece blank includes providing the blank as a continuous body.

16. A hobbing tool comprising:
a body that is elongated along a first axis of rotation; and
one or more cutting teeth encircling the body along at least a portion of a length of the body, the one or more cutting teeth spaced along the length of the body such that cutting teeth concurrently engage opposing first and second surfaces of a gear body blank, wherein the body is configured to be rotated about the first axis of rotation while the gear body blank is rotated about a second axis of rotation such that the one or more cutting teeth concurrently cut gear teeth in both of the first and second surfaces of the gear body blank.

17. The hobbing tool of claim 16, wherein the one or more cutting teeth includes at least a first cutting tooth in a first cutting segment and at least a second cutting tooth in a second cutting segment, the first and second cutting segments spaced apart from each other along the length of the body, the at least a first cutting tooth positioned to cut the gear teeth in the first surface of the gear body blank and the at least a second cutting tooth positioned to cut the gear teeth in the second surface of the gear body blank.

18. The hobbing tool of claim 17, wherein the first cutting segment and the second cutting segment of the body are separated by an interconnecting segment that is configured to engage a center hub region of the gear body blank that separates the first and second surfaces of the gear body blank when the one or more cutting teeth cut the gear teeth in the first and second surfaces of the gear body blank.

19. The hobbing tool of claim 18, wherein the interconnecting segment of the body is configured to engage the center hub region of the gear body blank without cutting gear teeth in the center hub region.

20. The hobbing tool of claim 16, wherein the body is configured to be oriented such that the first axis of rotation of the body is obliquely angled with respect to the second axis of rotation of the gear body blank when the one or more cutting teeth concurrently cut the gear teeth in the first and second surfaces of the gear body blank.
